(19) United States
(12) Patent Application Publication
(10) Pub. No.: US 2025/0182495 A1
(43) Pub. Date: Jun. 5, 2025

(54) MULTI-LAYER OBJECT SEGMENTATION FOR COMPLEX SCENES

(71) Applicant: QUALCOMM Incorporated, San Diego, CA (US)

(72) Inventors: Hazem Ahmed Mohamed Mohamed Rashed, Kronach (DE); Varun Ravi Kumar, San Diego, CA (US); Senthil Kumar Yogamani, Headford (IE)

(21) Appl. No.: 18/528,350

(22) Filed: Dec. 4, 2023

(51) Int. Cl. G06V 20/58; G01S 7/48; G06V 10/26; G06V 10/764; G06V 10/774; G06V 10/82

(52) U.S. Cl. CPC G06V 20/58; G01S 7/4802; G06V 10/26; G06V 10/764; G06V 10/774; G06V 10/82

(57) ABSTRACT

A system stores frames of data received from a sensor; determines a first class for a first layer for each pixel of a plurality of pixels in a frame of the frames; determines a second class for a second layer for each pixel of the plurality of pixels in the frame; identifies a first object in the frame based on the first class for each pixel of the plurality of pixels; and identifies a second object in the frame based on the first class for each pixel of the plurality of pixels and based on the second class for each pixel of the plurality of pixels, wherein a portion of the plurality of pixels correspond to both the first object and the second object.

### TECHNICAL FIELD

This disclosure relates to moving object segmentation systems, including moving object segmentation used for advanced driver-assistance systems (ADAS).

### BACKGROUND

An autonomous driving vehicle is a vehicle that is configured to sense the environment around the vehicle, such as the existence and location of other objects, and operating without human control. An autonomous driving vehicle may include a LiDAR (Light Detection and Ranging) system or other sensor system for sensing point cloud data indictive of the existence and location of other objects around the autonomous driving vehicle. In some examples, such an autonomous driving vehicle may be referred to as an ego vehicle. A vehicle having an ADAS is a vehicle that includes systems which may assist a driver in operating the vehicle, such as parking or driving the vehicle.

### SUMMARY

Camera and LiDAR systems may be used together in various different robotic and vehicular applications. One such vehicular application is an advanced driver assistance system (ADAS). ADAS is a system that utilizes both camera and LiDAR sensor technology to improve driving safety, comfort, and overall vehicle performance. This system combines the strengths of both sensors to provide a more comprehensive view of a vehicle's surroundings, enabling the ADAS to better assist the driver in various driving scenarios.

Occluded objects occur frequently in autonomous driving scenes. Such occlusions can lead to very small irregular parts of objects being completely separated within an image from the original object, and hence not having the same object pattern of the corresponding class. Although objects, such as automobiles, actually have fixed patterns, occlusion may cause object parts to have any shape. Training a DNN that objects such as cars may have any shape reduces the accuracy with which an ADAS performs moving object segmentation on a scene. For example, an ADAS may miss object parts when performing moving object segmentation. That is, an ADAS may only predict some, but not all, object parts of an object as belonging to the object. Thus, within a scene, some pixels may be predicted as corresponding to incorrect objects or to multiple objects. Additionally, as occlusion changes every image, and every object part is predicted separately, there may be temporal inconsistency of the shapes of objects which reduce the accuracy of various post processing applications, such as tracking. Additionally, when two or more objects of the same class are occluding, such as one car occluding another car, an ADAS may incorrectly assign tiny parts of one object to the wrong object. All of these issues potentially reduce the accuracy of an ADAS.

This disclosure proposes techniques for performing multi-layer object segmentation. To perform multi-layer object segmentation, each pixel within a frame may be associated with multiple layers, and an ADAS may assign each layer to a different class. Thus, the ADAS may assign a single pixel to multiple classes. For example, the set of classes to which a pixel may be assigned may include moving object, pedestrian, structure, and background. For a scene like FIG. 1 where a person occludes an automobile, the ADAS may assign a foreground layer to the class of pedestrian and may assign a background layer to the class of moving object. Generally speaking, each pixel may have N layers, with layer 0 (L0) corresponding to a foreground layer and layer N (LN) corresponding to a background layer. Each pixel may also have additional layers between L0 and LN. Each layer for each pixel may be assigned to a different class.

By determining a first class for a first layer for each pixel of a plurality of pixels in a frame and determining a second class for a second layer for each pixel of the plurality of pixels in the frame, an ADAS may be able to identify a first object in the frame based on the first class for each pixel of the plurality of pixels and identify a second object in the frame based on the first class for each pixel of the plurality of pixels and based on the second class for each pixel of the plurality of pixels, with a portion of the plurality of pixels corresponding to both the first object and the second object. For that portion of the plurality of pixels, the first layer and second layer of the pixels may be associated with different classes as compared to conventional techniques where each pixel would only be associated with once class. By enabling the plurality of pixels corresponding to both the first object and the second object to have different layers with different classifications, the ADAS may be able to more accurately identify and track occluded objects within a scene.

According to an example of this disclosure, a system includes one or more memories configured to store frames of data received from a sensor and processing circuitry configured to: receive a frame of the frames; determine a first class for a first layer for each pixel of a plurality of pixels in the frame; determine a second class for a second layer for each pixel of the plurality of pixels in the frame; identify a first object in the frame based on the first class for each pixel of the plurality of pixels; and identify a second object in the frame based on the first class for each pixel of the plurality of pixels and based on the second class for each pixel of the plurality of pixels, wherein a portion of the plurality of pixels correspond to both the first object and the second object.

According to an example of this disclosure, a method includes receiving a frame from a sensor; determining a first class for a first layer for each pixel of a plurality of pixels in the frame; determining a second class for a second layer for each pixel of the plurality of pixels in the frame; identifying a first object in the frame based on the first class for each pixel of the plurality of pixels; and identifying a second object in the frame based on the first class for each pixel of the plurality of pixels and based on the second class for each pixel of the plurality of pixels, wherein a portion of the plurality of pixels correspond to both the first object and the second object.

A computer-readable storage medium stores instructions that when executed by one or more processors cause the one or more processor to receive a frame from a sensor; determine a first class for a first layer for each pixel of a plurality of pixels in the frame; determine a second class for a second layer for each pixel of the plurality of pixels in the frame; identify a first object in the frame based on the first class for each pixel of the plurality of pixels; and identify a second object in the frame based on the first class for each pixel of the plurality of pixels and based on the second class for each pixel of the plurality of pixels, wherein a portion of the plurality of pixels correspond to both the first object and the second object.

The details of one or more examples are set forth in the accompanying drawings and the description below. Other features, objects, and advantages will be apparent from the description, drawings, and claims.

### BRIEF DESCRIPTION OF DRAWINGS

FIG. 1 is an example image of a scene that includes occluded objects.

FIG. 2 is a block diagram illustrating an example processing system according to one to more aspects of this disclosure.

FIG. 3 is an example image of a scene that includes occluded objects with the multi-layer object segmentation techniques of this disclosure.

FIG. 4 shows an example of a proposed framework for implementing the multi-layer moving object segmentation techniques of this disclosure.

FIG. 5 is a block diagram illustrating an encoder-decoder architecture for processing image data and position data to generate an output, in accordance with one or more techniques of this disclosure.

FIG. 6 is a flowchart illustrating an example process for performing multi-layer moving object segmentation in accordance with one or more techniques of this disclosure.

### DETAILED DESCRIPTION

Camera and LiDAR systems may be used together in various different robotic and vehicular applications. One such vehicular application is an advanced driver assistance system (ADAS). ADAS is a system that utilizes both camera and LiDAR sensor technology to improve driving safety, comfort, and overall vehicle performance. This system combines the strengths of both sensors to provide a more comprehensive view of a vehicle's surroundings, enabling the ADAS to better assist the driver in various driving scenarios.

In some examples, the camera-based system is responsible for capturing high-resolution images and processing the images in real time. The output images of such a camera-based system may be used in applications such as depth estimation, object detection, and/or pose detection, including the detection and recognition of objects, such as other vehicles, pedestrians, traffic signs, and lane markings. Cameras may be particularly good at capturing color and texture information, which is useful for accurate object recognition and classification.

LiDAR sensors emit laser pulses to measure the distance, shape, and positioning of objects around the vehicle. LiDAR sensors provide 3D data, enabling the ADAS to create a detailed map of the surrounding environment. LiDAR may be particularly effective in low-light or certain adverse weather conditions, where camera performance may be hindered. In some examples, the output of a LiDAR sensor may be used as partial ground truth data for performing neural network-based depth information on corresponding camera images.

By fusing the data gathered from both camera and LiDAR sensors, the ADAS can deliver enhanced situational awareness and improved decision-making capabilities. This enables various driver assistance features such as adaptive cruise control, lane keeping assist, pedestrian detection, automatic emergency braking, and parking assistance. The combined system can also contribute to the development of semi-autonomous and fully autonomous driving technologies, which may lead to a safer and more efficient driving experience.

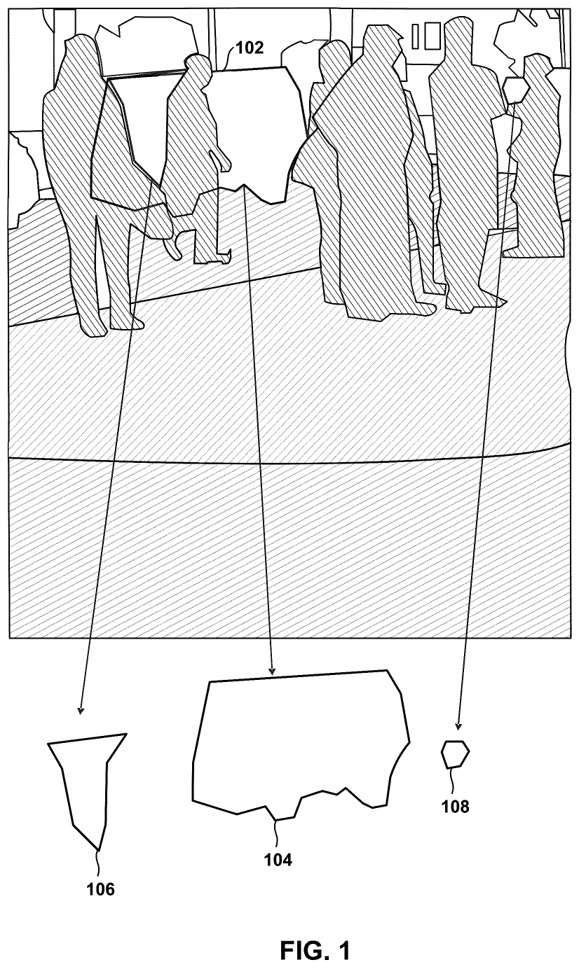

Occluded objects occur frequently in autonomous driving scenes. Such occlusions can lead to very small irregular parts of objects being completely separated within an image from the original object, and hence not having the same object pattern of the corresponding class. Referring to FIG. 1, for example, car 102 is occluded by people. Object part 104 is sufficiently large and unique such that that an ADAS, using a dynamic neural network (DNN) for example, can be trained to accurately determine that object part 104 corresponds to a car. Due to the occlusion by the people, however, object parts 106 and 108 are small and irregular and have shapes that bare little resemblance to cars. To perform accurate moving object segmentation, a DNN of an ADAS needs to be able to identify that object parts 106 and 108 correspond to a car and preferably to determine that object parts 106 and 108 correspond to the same car as each other and as object part 104. Training a DNN to associate shapes like object parts 106 and 108 with a car may, however, actually reduce the accuracy of the DNN with respect to detecting cars by training the DNN that a car may effectively have any shape.

Although objects, such as automobiles, actually have fixed patterns, occlusion may cause object parts to have any shape. Training a DNN that objects such as cars may have any shape reduces the accuracy with which an ADAS performs moving object segmentation on a scene. For example, an ADAS may miss object parts when performing moving object segmentation. That is, an ADAS may only predict some, but not all, object parts of an object as belonging to the object. Thus, within a scene, some pixels may be predicted as corresponding to incorrect objects or to multiple objects. Additionally, as occlusion changes every image, and every object part is predicted separately, there may be temporal inconsistency of the shapes of objects which reduce the accuracy of various post processing applications, such as tracking. Additionally, when two or more objects of the same class are occluding, such as one car occluding another car, an ADAS may incorrectly assign tiny parts of one object to the wrong object. All of these issues potentially reduce the accuracy of an ADAS.

This disclosure proposes techniques for performing multi-layer object segmentation. To perform multi-layer object segmentation, each pixel within a frame may be associated with multiple layers, and an ADAS may assign each layer to a different class. Thus, the ADAS may assign a single pixel to multiple classes. For example, the set of classes to which a pixel may be assigned may include moving object, pedestrian, structure, and background. For a scene like FIG. 1 where a person occludes an automobile, the ADAS may assign a foreground layer to the class of pedestrian and may assign a background layer to the class of moving object. Generally speaking, each pixel may have N layers, with layer 0 (L0) corresponding to a foreground layer and layer N (LN) corresponding to a background layer. Each pixel may also have additional layers between L0 and LN. Each layer for each pixel may be assigned to a different class.

By determining a first class for a first layer for each pixel of a plurality of pixels in a frame and determining a second class for a second layer for each pixel of the plurality of pixels in the frame, an ADAS may be able to identify a first object in the frame based on the first class for each pixel of the plurality of pixels and identify a second object in the frame based on the first class for each pixel of the plurality of pixels and based on the second class for each pixel of the plurality of pixels, with a portion of the plurality of pixels corresponding to both the first object and the second object. For that portion of the plurality of pixels, the first layer and second layer of the pixels may be associated with different classes as compared to conventional techniques where each pixel would only be associated with once class. By enabling the plurality of pixels corresponding to both the first object and the second object to have different layers with different classifications, the ADAS may be able to more accurately identify and track occluded objects within a scene.

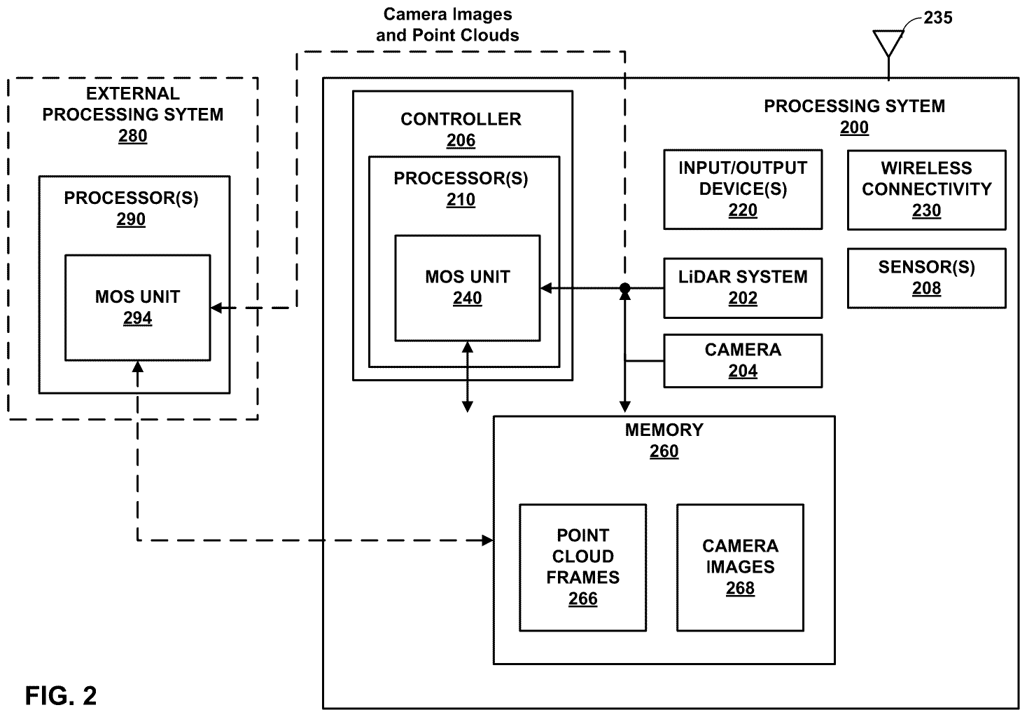

FIG. 2 is a block diagram illustrating an example processing system according to one to more aspects of this disclosure. Processing system 200 may be used in a vehicle, such as an autonomous driving vehicle or an assisted driving vehicle (e.g., a vehicle having an ADAS or an “ego vehicle”). In such an example, processing system 200 may represent an ADAS. In other examples, processing system 200 may be used in other robotic applications that may include both a camera and a LiDAR system.

Processing system 200 may include LiDAR system 202, camera 204, controller 206, one or more sensor(s) 208, input/output device(s) 220, wireless connectivity component 230, and memory 260. LiDAR system 202 may include one or more light emitters (e.g., lasers) and one or more light sensors. LiDAR system 202 may be deployed in or about a vehicle. For example, LiDAR system 202 may be mounted on a roof of a vehicle, in bumpers of a vehicle, and/or in other locations of a vehicle. LiDAR system 202 may be configured to emit light pulses and sense the light pulses reflected off of objects in the environment. LiDAR system 202 may emit such pulses in a 360 degree field around so as to detect objects within the 360 degree field, such as objects in front of, behind, or beside a vehicle. While described herein as including LiDAR system 202, it should be understood that another distance or depth sensing system may be used in place of LiDAR system 202. The output of LiDAR system 202 are called point clouds or point cloud frames.

A point cloud frame output by LiDAR system 202 is a collection of 3D data points that represent the surface of objects in the environment. These points are generated by measuring the time it takes for a laser pulse to travel from the sensor to an object and back. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization. Intensity values can be used to generate a grayscale image of the point cloud, helping to highlight the structure and features in the data.

Color information in a point cloud is usually obtained from other sources, such as digital cameras mounted on the same platform as the LiDAR sensor, and then combined with the LiDAR data. The color attribute consists of color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera 204 may be any type of camera configured to capture video or image data in the environment around processing system 200 (e.g., around a vehicle). For example, camera 204 may include a front facing camera (e.g., a front bumper camera, a front windshield camera, and/or a dashcam), a back facing camera (e.g., a backup camera), side facing cameras (e.g., cameras mounted in sideview mirrors). Camera 204 may be a color camera or a grayscale camera. In some examples, camera 204 may be a camera system including more than one camera sensor. While techniques of this disclosure will be described with reference to a 2D photographic camera, the techniques of this disclosure may be applied to the outputs of other sensors that capture information at a higher frame rate than a LiDAR sensor, including a sonar sensor, a radar sensor, an infrared camera, and/or a time-of-flight (ToF) camera.

Wireless connectivity component 230 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 230 is further connected to one or more antennas 235.

Processing system 200 may also include one or more input and/or output devices 220, such as screens, touch-sensitive surfaces (including touch-sensitive displays), physical buttons, speakers, microphones, and the like. Input/output device(s) 220 (e.g., which may include an I/O controller) may manage input and output signals for processing system 200. In some cases, input/output device(s)120 may represent a physical connection or port to an external peripheral. In some cases, input/output device(s) 220 may utilize an operating system. In other cases, input/output device(s) 220 may represent or interact with a modem, a keyboard, a mouse, a touchscreen, or a similar device. In some cases, input/output device(s) 220 may be implemented as part of a processor (e.g., a processor of processor(s) 210). In some cases, a user may interact with a device via input/output device(s) 220 or via hardware components controlled by input/output device(s) 220.

Controller 206 may be an autonomous or assisted driving controller (e.g., an ADAS) configured to control operation of processing system 200 (e.g., including the operation of a vehicle). For example, controller 206 may control acceleration, braking, and/or navigation of vehicle through the environment surrounding vehicle. Controller 206 may include one or more processors, e.g., processor(s) 210. Processor(s) 210 may include one or more central processing units (CPUs), such as single-core or multi-core CPUs, graphics processing units (GPUs), digital signal processor (DSPs), neural processing unit (NPUs), multimedia processing units, and/or the like. Instructions executed by processor(s) 210 may be loaded, for example, from memory 260 and may cause processor(s) 210 to perform the operations attributed to processor(s) 210 in this disclosure. In some examples, one or more of processor(s) 210 may be based on an ARM or RISC-V instruction set.

An NPU is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processor(s) 210 may also include one or more sensor processing units associated with LiDAR system 202, camera 204, and/or sensor(s) 208. For example, processor(s) 210 may include one or more image signal processors associated with camera 204 and/or sensor(s) 208, and/or a navigation processor associated with sensor(s) 208, which may include satellite-based positioning system components (e.g., GPS or GLONASS) as well as inertial positioning system components. In some aspects, sensor(s) 208 may include direct depth sensing sensors, which may function to determine a depth of or distance to objects within the environment surrounding processing system 200 (e.g., surrounding a vehicle).

Processing system 200 also includes memory 260, which is representative of one or more static and/or dynamic memories, such as a dynamic random access memory, a flash-based static memory, and the like. In this example, memory 260 includes computer-executable components, which may be executed by one or more of the aforementioned components of processing system 200.

Examples of memory 260 include random access memory (RAM), read-only memory (ROM), or a hard disk. Examples of memory 260 include solid state memory and a hard disk drive. In some examples, memory 260 is used to store computer-readable, computer-executable software including instructions that, when executed, cause a processor to perform various functions described herein. In some cases, memory 260 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 260 store information in the form of a logical state.

Processor(s) 210, e.g., MOS unit 240, may perform multi-layer moving object segmentation on a set of point clouds from point cloud frames 266 stored in memory 260 to identify at least one moving object in a scene of the point clouds. Processor(s) 210, e.g., MOS unit 240, may additionally or alternatively perform multi-layer moving object segmentation on a set of camera images from camera images 268 to identify the at least one moving object in a scene of the camera images.

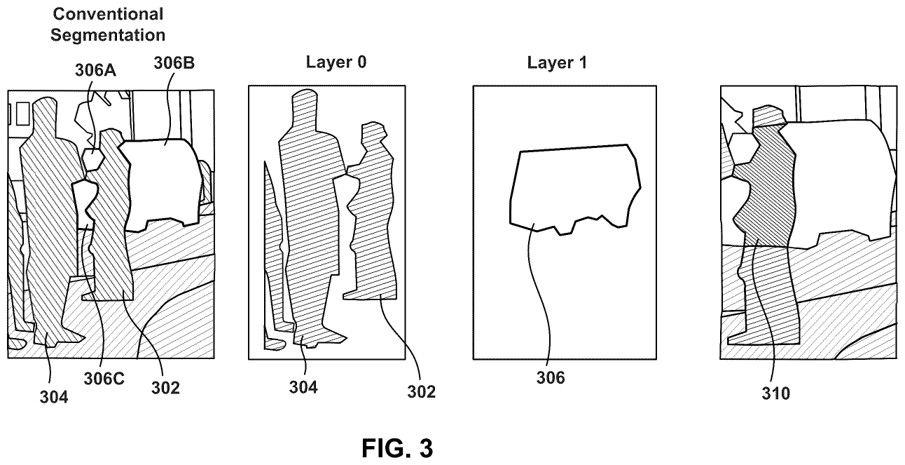

Referring to FIG. 3, if performing conventional, single layer segmentation, MOS unit 240 may separately classify objects 302, 304, 306A, 306B, and 306C. As objects 306A and 306C are relatively small, such classification may be inaccurate and/or cause the other problems described in this disclosure.

If performing multi-layer objection segmentation as described herein, MOS unit 240 may identify objects 304 and 302 as belonging to a first layer (e.g., layer 0) and object 306 as belonging to a different layer (e.g., layer 1). MOS unit 240 may additionally identify a group of pixels (e.g., pixels 310) that belong to more than one object, such as pixels 310 which belong to both object 302 and object 306.

To perform multi-layer segmentation, MOS unit 240 may, for example, receive a frame of data, e.g., a point cloud frame from points cloud frames 266 or an image from camera images 268. MOS unit 240 may determine a first class for a first layer for each pixel of a plurality of pixels in the frame and determine a second class for a second layer for each pixel of the plurality of pixels in the frame. MOS unit 240 may identify a first object in the frame based on the first class for each pixel of the plurality of pixels and identify a second object in the frame based on the first class for each pixel of the plurality of pixels and based on the second class for each pixel of the plurality of pixels. A portion of the plurality of pixels may correspond to both the first object and the second object. For example, in FIG. 3, object 302 may be classified as a person, and object 306 as an automobile. For pixels 310, the first class for the first layer for each pixel may be person while the second class the second layer for each pixel may be automobile.

Although the example of FIG. 3 only shows two layers, in some implementations, each pixel may have more than two layers. In some examples, MOS unit 240 may change number of layers for each pixels in the frame based on a scenario of the frame. The scenario may, for example, be a location (e.g., highway, urban, etc.) of processing system 200 when the frame is acquired, a speed of processing system 200 when the frame is acquired, a complexity of the scene in the frame, or some other such criteria for the frame.

MOS unit 240 may for example determine the first class for the first layer for each pixel of the plurality of pixels in the frame and the second class for the second layer for each pixel of the plurality of pixels in the frame by inputting the frame into a DNN that has been trained using multi-layer training data.

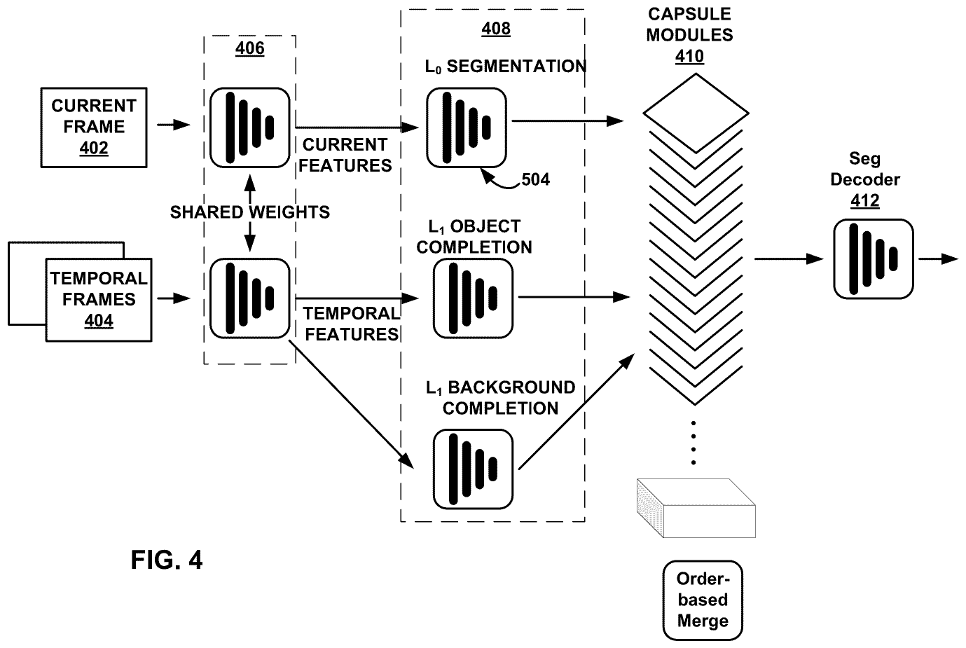

FIG. 4 shows an example of a proposed framework for implementing the multi-layer moving object segmentation techniques of this disclosure. The framework takes an input image (current frame 402) an/or sequence of images (temporal frames 404) as input. The input is passed through convolutional neural network(s) (CNN(s)) 406 to extract features (current features from current frame 402 and temporal features from temporal frames 404). Weights may be shared between the CNN(s) 406. In this context, the weights generally refer to the parameters of a trained CNN.

The features output from CNN(s) 406 are then transformed by feature decoders 408 (the L0, L1, and, Ln feature decoders) into a set of capsule modules 410. Each capsule represents a group of features that correspond to a specific object or part in the input. The capsule outputs are then sent through a series of dynamic routing iterations to compute the coupling coefficients between capsules. These coupling coefficients represent the agreement between capsules on the presence of specific objects or parts in the input. The dynamic routing algorithm helps to identify the most relevant capsules for a given input and may improves the ability of the network to handle occlusion and deformation. The capsule outputs are then weighted by an attention vector to emphasize the most important features in the input. The attention vector can be generated by a separate attention network or learned through a soft attention mechanism based on the input features. The weighted capsule outputs are then transformed back into a set of features using a set of decoder feature layers. These features are then passed through a decoder network 412 to generate the final output, which can be a segmentation mask, a classification label, or a sequence of predictions.

The techniques of this disclosure may utilize dynamic routing in capsule networks. In capsule networks, the output of each capsule is a vector that represents the properties of an entity or object in an image. The output vectors of capsules in the lower layers are used to compute the output vectors of capsules in the higher layers, using a process called dynamic routing. Dynamic routing allows higher-level capsules to vote on the existence and properties of lower-level capsules. Each higher-level capsule sends its output vector as a “vote” to some or all of the lower-level capsules. The lower-level capsules then weight these votes based on how well their properties match the properties of the higher-level capsule, using a process called the agreement function. The weighted votes are then summed to compute the output vector of the higher-level capsule.

This technique may used to combine the outputs of the layers in the multi-layer segmentation approach described herein. That is, each layer may correspond to a “capsule” that represents the properties of the objects in that layer. The system may then use dynamic routing to allow higher-level layers to vote on the existence and properties of lower-level layers and to combine the outputs of all layers into a final feature vector.

Each layer L0 to Ln may be treated as a capsule, with an output vector that represents the properties of the objects in that layer. Each layer may send its output vector as a “vote” to the higher-level layers. Each higher-level layer may compute a weight for each vote based on how well the properties of the lower-level layer match the properties of the higher-level layer, using an agreement function. For example, the weight may be computed as the dot product between the output vectors of the two layers. The weights are normalized using a softmax function to ensure that all the weights sum to 1. The output vector of each higher-level layer may be computed as the weighted sum of the output vectors of lower-level layers, using the normalized weights as the weights.

The final feature vector may be computed as the concatenation of the output vectors of all layers. The equation for computing the output vector of a higher-level layer Lk, given the output vectors of all lower-level layers L0 to Lk−1 may be determined as follows:

$$vk = concatenate ( [ 0 , … , vk - 1 ] )$$

$$ai , j = soft max ( w [ i , j ] )$$

$$ui = sum ( a [ i , j ] * vj )$$

$$vk = squash ( u [ k ] )$$

In this equation, νk is the concatenation of the output vectors of lower-level layers; α[i,j] is the weight of the vote of layer j for layer i; w[i,j] is a learnable weight matrix that determines the agreement function between layers i and j; u[i] is the weighted sum of the output vectors of all lower-level layers for layer i, and ν[k] is the output vector of layer k after applying a non-linear squashing function. The squashing function is used to ensure that the output vector has a length between 0 and 1, and represents the probability that the object represented by the layer exists.

In the context of segmentation, the capsule network may be used to generate a mask for each object in the input image. This may be done by first applying the convolutional layers to extract low-level features, and then using the capsule layers to group these features into higher-level representations of objects. The output of each secondary capsule may be used to generate a mask for the corresponding object by thresholding the activation vector.

The capsule network may have several advantages over traditional convolutional neural networks, one of the main advantages being that it is more interpretable, as the capsule representation allows for explicit modeling of object properties such as orientation and position.

Additionally, the dynamic routing algorithm allows the network to handle variations in object position and orientation, which can be especially important in autonomous driving scenarios where objects may be partially occluded or in different orientations.

In a capsule network, the output of each layer is a set of vectors, rather than a single scalar value as in a traditional neural network. This allows the network to explicitly model the spatial relationships between objects in an image, as well as their various properties.

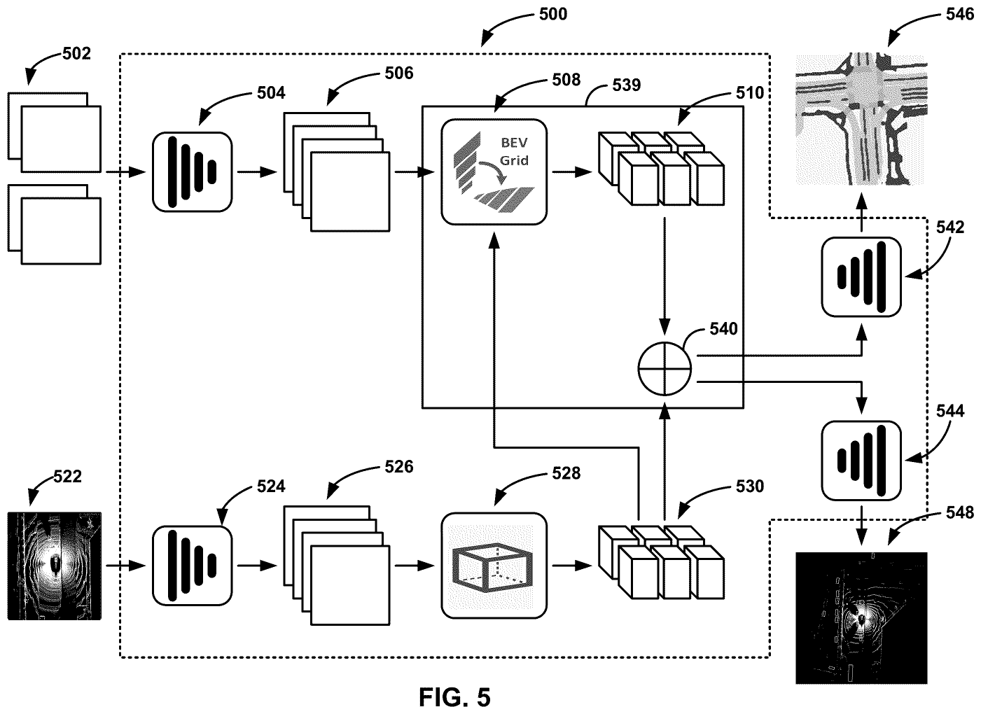

FIG. 5 is a block diagram illustrating an encoder-decoder architecture 500 for processing image data and position data to generate an output, in accordance with one or more techniques of this disclosure. In some examples, encoder-decoder architecture 500 may be a part of ADAS controller 206 of FIG. 2. Where applicable, the techniques of FIG. 5 will be described with respect to processing system 200 of FIG. 2, but it should be understood that encoder-decoder architecture 500 may also be implemented into other systems.

FIG. 5 shows camera images 502, first encoder 504, perspective view features 506, projection unit 508, first set of bird's eye view (BEV) features 510, point cloud frames 522, second encoder 524, 3D sparse features 526, flattening unit 528, second set of BEV features 530, BEV feature fusion unit 540, first decoder 542, second decoder 544, first output 546, and second output 548. Although the techniques of FIG. 5 will be described with respect to camera images 502 and point cloud frames 522, it should be understood that the techniques of FIG. 5 are generally applicable to systems that utilize other frames of data from other modalities of sensors.

Camera images 502 represents a set of camera images acquired by camera system 204. Camera images 502 may be received from a plurality of cameras at different locations and/or different fields of view, which may be overlapping. In some examples, encoder-decoder architecture 500 processes camera images 502 in real time or near real time so that as camera(s) 204 captures camera images 502, encoder-decoder architecture 300 processes the captured camera images. In some examples, camera images 502 may represent one or more perspective views of one or more objects within a 3D space where processing system 200 is located. That is, the one or more perspective views may represent views from the perspective of processing system 200.

Encoder-decoder architecture 500 includes encoders 504, 524 and decoders 542, 544. Encoder-decoder architecture 500 may be configured to process image data and position data (e.g., point cloud data). An encoder-decoder architecture for image feature extraction is commonly used in computer vision tasks, such as image captioning, image-to-image translation, and image generation. The encoder-decoder architecture may transform input data into a compact and meaningful representation known as a feature vector that captures salient visual information from the input data. The encoder may extract features from the input data, while the decoder reconstructs the input data from the learned features.

In some cases, an encoder is built using convolutional neural network (CNN) layers to analyze input data in a hierarchical manner. The CNN layers may apply filters to capture local patterns and gradually combine them to form higher-level features. Each convolutional layer extracts increasingly complex visual representations from the input data. These representations may be compressed and down sampled through operations such as pooling or strided convolutions, reducing spatial dimensions while preserving desired information. The final output of the encoder may represent a flattened feature vector that encodes the input data's high-level visual features.

A decoder may be built using transposed convolutional layers or fully connected layers, and may reconstruct the input data from the learned feature representation. A decoder may take the feature vector obtained from the encoder as input and processes it to generate an output that is similar to the input data. The decoder may up-sample and expand the feature vector, gradually recovering spatial dimensions lost during encoding. A decoder may apply transformations, such as transposed convolutions or deconvolutions, to reconstruct the input data. The decoder layers progressively refine the output, incorporating details and structure until a visually plausible image is generated.

During a training phase, usually prior to deployment, an encoder-decoder architecture for feature extraction may be trained using a loss function that measures the discrepancy between the reconstructed image and the ground truth image. This loss guides the learning process, encouraging the encoder to capture meaningful features and the decoder to produce accurate reconstructions. The training process may involve minimizing the difference between the generated image and the ground truth image, typically using backpropagation and gradient descent techniques. Encoders and decoders of encoder-decoder architecture 500 may be trained using various training data.

An encoder-decoder architecture for image and/or position feature extraction may comprise one or more encoders that extract high-level features from the input data and one or more decoders that reconstruct the input data from the learned features. This architecture may allow for the transformation of input data into compact and meaningful representations. The encoder-decoder framework may enable the model to learn and utilize important visual and positional features, facilitating tasks like image generation, captioning, and translation.

First encoder 504 may represent an encoder of a neural network or another kind of model that is configured to extract information from input data and process the extracted information to generate an output. In general, encoders are configured to receive data as an input and extract one or more features from the input data. The features are the output from the encoder. The features may include one or more vectors of numerical data that can be processed by a machine learning model. These vectors of numerical data may represent the input data in a way that provides information concerning characteristics of the input data. In other words, encoders are configured to process input data to identify characteristics of the input data.

In some examples, the first encoder 504 represents a CNN, another kind of artificial neural network (ANN), or another kind of model that includes one or more layers and/or nodes. Each layer of the one or more layers may include one or more nodes. Examples of layers include input layers, output layers, and hidden layers between the input layers and the output layers. A CNN, for example, may include one or more convolutional layers comprising convolutional filters. Each convolutional filter may perform one or more mathematical operations on the input data to detect one or more features such as edges, shapes, textures, or objects. CNNs may additionally or alternatively include activation functions that identify complex relationships between elements of an image and pooling layers that recognize patterns regardless of location within the image frame.

First encoder 504 may generate a set of perspective view features 506 based on camera images 502. Perspective view features 506 may provide information corresponding to one or more objects depicted in camera images 502 from the perspective of camera(s) 204 which captures camera images 502. For example, perspective view features 506 may include vanishing points and vanishing lines that indicate a point at which parallel lines converge or disappear, a direction of dominant lines, a structure or orientation of objects, or any combination thereof. Perspective view features 506 may include color information. Additionally, or alternatively, perspective view features 506 may include key points that are matched across a group of two or more camera images of camera images 502. Key points may allow encoder-decoder architecture 500 to determine one or more characteristics of motion and pose of objects. Perspective view features 506 may, in some examples, include depth-based features that indicate a distance of one or more objects from the camera, but this is not required. Perspective view features 506 may include any one or combination of image features that indicate characteristics of camera images 502.

It may be beneficial for encoder-decoder architecture 500 to transform perspective view features 506 into BEV features that represent the one or more objects within the 3D environment on a grid from a perspective looking down at the one or more objects from a position above the one or more objects. Since encoder-decoder architecture 500 may be part of an ADAS for controlling a vehicle, and since vehicles move generally across the ground in a way that is observable from a bird's eye perspective, generating BEV features may allow a control unit (e.g., controller 208 of processing system 200) of FIG. 2 to control the vehicle based on the representation of the one or more objects from a bird's eye perspective. Encoder-decoder architecture 500 is not limited to generating BEV features for controlling a vehicle. Encoder-decoder architecture 500 may generate BEV features for controlling another object such as a robotic arm and/or perform one or more other tasks involving image segmentation, depth detection, object detection, or any combination thereof.

Projection unit 508 may transform perspective view features 506 into a first set of BEV features 510. In some examples, projection unit 508 may generate a 2D grid and project the perspective view features 506 onto the 2D grid. For example, projection unit 508 may perform perspective transformation to place objects closer to the camera on the 2D grid and place objects further form the camera on the 2D grid. In some examples, the 2D grid may include a predetermined number of rows and a predetermined number of columns, but this is not required. Projection unit 508 may, in some examples, set the number of rows and the number of columns. In any case, projection unit 508 may generate the first set of BEV features 510 that represent information present in perspective view features 506 on a 2D grid including the one or more objects from a perspective above the one or more objects looking down at the one or more objects.

In some examples, projection unit 508 may use one or more self-attention blocks and/or cross-attention blocks to transform perspective view features 506 into the first set of BEV features 510. Cross-attention blocks may allow projection unit 508 to process different regions and/or objects of perspective view features 506 while considering relationships between the different regions and/or objects. Self-attention blocks may capture long-range dependencies within perspective view features 506. This may allow a BEV representation of the perspective view features 506 (e.g., the first set of BEV features 510) to capture relationships and dependencies between different elements, objects, and regions in the BEV representation.

Point cloud frames 522 may be examples of point cloud frames 266 of FIG. 2. In some examples, encoder-decoder architecture 500 processes point cloud frames 522 in real time or near real time so that as LiDAR system 202 generates point cloud frames 522, encoder-decoder architecture 500 processes the captured point cloud frames. In some examples, point cloud frames 522 may represent collections of point coordinates within a 3D space (e.g., x, y, z coordinates within a Cartesian space) where LiDAR system 202 is located. Since LiDAR system 202 is configured to emit light signals and receive light signals reflected off surfaces of one or more objects, the collections of point coordinates may indicate a shape and a location of surfaces of the one or more objects within the 3D space.

Second encoder 524 may represent an encoder of a neural network or another kind of model that is configured to extract information from input data and process the extracted information to generate an output. Second encoder 524 may be similar to first encoder 504 in that both the first encoder 504 and the second encoder 524 are configured to process input data to generate output features. But in some examples, first encoder 504 is configured to process 2D input data and second encoder 524 is configured to process 3D input data. In some examples, processing system 200 is configured to train first encoder 504 using a set of training data that includes one or more training camera images, and processing system 200 is configured to train second encoder 524 using a set of training data that includes one or more point cloud frames. That is, processing system 200 may train first encoder 504 to recognize one or more patterns in camera images that correspond to certain camera image perspective view features and processing system 200 may train second encoder 524 to recognize one or more patterns in point cloud frames that correspond to certain 3D sparse features.

Second encoder 524 may generate a set of 3D sparse features 526 based on point cloud frames 522. 3D sparse features 526 may provide information corresponding to one or more objects indicated by point cloud frames 522 within a 3D space that includes LiDAR system 202 which captures point cloud frames 522. 3D sparse features 526 may include key points within point cloud frames 522 that indicate unique characteristics of the one or more objects. For example, key points may include corners, straight edges, curved edges, peaks of curved edges. Encoder-decoder architecture 500 may recognize one or more objects based on key points. 3D sparse features 526 may additionally or alternatively include descriptors that allow second encoder 524 to compare and track key points across groups of two or more point cloud frames of point cloud frames 522. Other kids of 3D sparse features 526 include voxels and super pixels.

Flattening unit 528 may transform 3D sparse features 526 into a second set of BEV features 530. In some examples, flattening unit 528 may define a 2D grid of cells and project the 3D sparse features onto the 2D grid of cells. For example, flattening unit 528 may project 3D coordinates of 3D sparse features (e.g., cartesian coordinates key points, voxels) onto a corresponding 2D coordinate of the 2D grid of cells. Flattening unit 528 may aggregate one or more sparse features within each cell of the 2D grid of cells. For example, flattening unit 528 may count a number of features within a cell, average attributes of features within a cell, or take a minimum or maximum value of a feature within a cell. Flattening unit 528 may normalize the features within each cell of the 2D grid of cells, but this is not required. Flattening unit 528 may flatten the features within each cell of the 2D grid of cells into a 2D array representation that captures characteristics of the 3D sparse features projected into each cell of the 2D grid of cells.

Since point cloud frames 522 represent multi-dimensional arrays of cartesian coordinates, flattening unit 528 may generate the second set of BEV features 530 by compressing one of the dimensions of the x, y, z cartesian space into a flattened plane without compressing the other two dimensions. That is, the points within a column of points parallel to one of the dimensions of the x, y, z cartesian space may be compressed into a single point on a 2D space formed by the two dimensions that are not compressed. Perspective view features 506 extracted from camera images 502, on the other hand, might not include cartesian coordinates. This means that it may be beneficial for projection unit 508 to receive the second set of BEV features 530 to aid in projecting perspective view features 506 onto a 2D BEV space to generate the first set of BEV features 510.

Projection unit 508 may generate the first set of BEV features 510 in a way that weighs an importance of image data for indicating characteristics of the 3D environment corresponding to processing system 200 and an importance of position data for indicating characteristics of the 3D environment corresponding to processing system 200. Image data may include information corresponding to one or more objects within the 3D environment that is not present in position data, and position data may include one information corresponding to one or more objects within the 3D environment that is not present in image data.

In some cases, information present in image data that is not present in position data is more important for generating an output to perform one or more tasks, and in other cases, information present in image data that is not present in position data is less important for generating an output to perform one or more tasks. In some cases, information present in position data that is not present in image data is more important for generating an output to perform one or more tasks, and in other cases, information present in position data that is not present in image data is less important for generating an output to perform one or more tasks. This means that it may be beneficial for projection unit 508 to generate the first set of BEV features 510 to account for the relevant importance of image data and position data for indicating characteristics of the 3D environment that are useful for generating an output.

To account for the relative importance of image data and position data for identifying characteristics of the 3D environment that are useful for generating an output to perform one or more tasks, projection unit 508 may condition perspective view features 506 extracted from camera images 502 and condition the second set of BEV features 530 generated from the 3D sparse features 526 extracted from point cloud frames 522 to determine a weighted summation. This weighted summation may indicate the relative importance of camera images 502 and the relative importance of point cloud frames 522 for generating an output to perform one or more tasks. Projection unit 508 may use the weighted summation to generate the first set of BEV features 510 to account for the relative importance of camera images 502 and the relative importance of point cloud frames 522 for generating an output to perform one or more tasks.

In some examples, point cloud frames 522 may include more precise position information indicating a location of one or more objects within the 3D environment, and camera images 502 may include less precise information concerning the position of one or more objects. For example, point cloud frames 522 may indicate a precise location, in Cartesian coordinates, of two objects. The Cartesian coordinates may indicate a precise distance of each of the two objects from LiDAR system 202. Camera images 502 may depict visual characteristics of each of the two objects including color, texture, and shape information, but might not include information concerning the precise distance of each of the two objects from camera(s) 204. Camera images 502 may indicate that one of the objects is between the other object and camera(s) 204, but might not indicate precise distances.

Projection unit 508 may condition perspective view features 506 and condition the second set of BEV features 530 to determine the weighted summation so that the first set of BEV features 510 indicates more useful information corresponding to each object of one or more objects within the 3D environment as compared with BEV features generated using other techniques. For example, when the precise location of a pedestrian is important for generating an output to control a vehicle, the weighted summation may weight position data features more heavily than the weighted summation weights image data features for indicating characteristics of the pedestrian in the first set of BEV features 510. When the text on a traffic sign and/or the color of a stoplight is important for generating an output to control a vehicle, the weighted summation may weight image data features more heavily than the weighted summation weights position data features for indicating characteristics of the traffic sign and/or the stoplight for indicating characteristics of the traffic sign and/or the stoplight in the first set of BEV features 510. That is, the weighted summation may weight the relative importance of image data and position data for indicating the characteristic of each object and/or each region of one or more objects and regions in the 3D environment. This may ensure that the set of BEV features 510 include more relevant information concerning the 3D environment for generating an output to perform one or more tasks as compared with BEV features generated using other techniques.

To condition perspective view features 506 and condition the second set of BEV features 530, projection unit 508 may use one or more positional encoding models trained using training data. For example, projection unit 508 may use a first positional encoding model to condition perspective view features 506 and use the first positional encoding model to condition the second set of BEV features 530. Based on the conditioned perspective view features 506, the conditioned second set of BEV features 530, and the first positional encoding model, projection unit 508 may determine the weighted summation. Additionally, or alternatively, projection unit 508 may use a second feature conditioning module to condition the perspective view features 506. Based on the weighted summation, perspective view features 506, and/or the conditioned perspective view features 506 conditioned using the second positional encoding model, projection unit 508 may generate the first set of BEV features 510.

In some examples, a projection and fusion unit 539 may include projection unit 508 and BEV feature fusion unit 540. BEV feature fusion unit 540 may be configured to fuse the first set of BEV features 510 and the second set of BEV features 530 to generate a fused set of BEV features. In some examples, BEV feature fusion unit 540 may use a concatenation operation to fuse the first set of BEV features 510 and the second set of BEV features 530. The concatenation operation may combine the first set of BEV features 510 and the second set of BEV features 530 so that the fused set of BEV features includes useful information present in each of the first set of BEV features 510 and the second set of BEV features 530. By using projection unit 508 to generate the first set of BEV features 510 to indicate the relative importance of each of position data and image data for indicating characteristics of the 3D environment, BEV feature fusion unit 540 may be configured to fuse the first set of BEV features 510 and the second set of BEV features 530 in a way that indicates a greater amount of useful information for generating an output as compared with systems that do not generate BEV features for image data to account for the relative importance of image data and position data.

Encoder-decoder architecture 500 may include first decoder 542 and second decoder 544. In some examples, each of first decoder 542 and second decoder 544 may represent a CNN, another kind of ANN, or another kind of model that includes one or more layers and/or nodes. Each layer of the one or more layers may include one or more nodes. Examples of layers include input layers, output layers, and hidden layers between the input layers and the output layers. In some examples, a decoder may include a series of transformation layers. Each transformation layer of the set of transformation layers may increase one or more spatial dimensions of the features, increase a complexity of the features, or increase a resolution of the features. A final layer of a decoder may generate a reconstructed output that includes an expanded representation of the features extracted by an encoder.

First decoder 542 may be configured to generate a first output 546 based on the fused set of BEV features. The first output 546 may comprise a 2D BEV representation of the 3D environment corresponding to processing system 200. For example, when processing system 200 is part of an ADAS for controlling a vehicle, the first output 546 may indicate a BEV view of one or more roads, road signs, road markers, traffic lights, vehicles, pedestrians, and other objects within the 3D environment corresponding to processing system 200. This may allow processing system 200 to use the first output 546 to control the vehicle within the 3D environment.

Since the output from first decoder 542 includes a bird's eye view of one or more objects that are in a 3D environment corresponding to encoder-decoder architecture 500, a control unit (e.g., controller 208 of FIG. 2) may use the output from first decoder 542 to control an object (e.g., a vehicle, one or more robotic components) within the 3D environment. For example, when the output from first decoder 542 indicates a vehicle ahead of a vehicle corresponding to processing system 200, the control unit may control the vehicle to change lanes to pass the other vehicle. In another example, when the output from first decoder 542 indicates a stop sign ahead, the control unit may control the vehicle to stop at an intersection.

Second decoder 544 may be configured to generate a second output 548 based on the fused set of BEV features. In some examples, the second output 548 may include a set of 3D bounding boxes that indicate a shape and a position of one or more objects within a 3D environment. In some examples, it may be important to generate 3D bounding boxes to determine an identity of one or more objects and/or a location of one or more objects. When processing system 200 is part of an ADAS for controlling a vehicle, processing system 200 may use the second output 548 to control the vehicle within the 3D environment. A control unit (e.g., controller 208 of FIG. 2) may process the second output 548 to perform one or more actions.

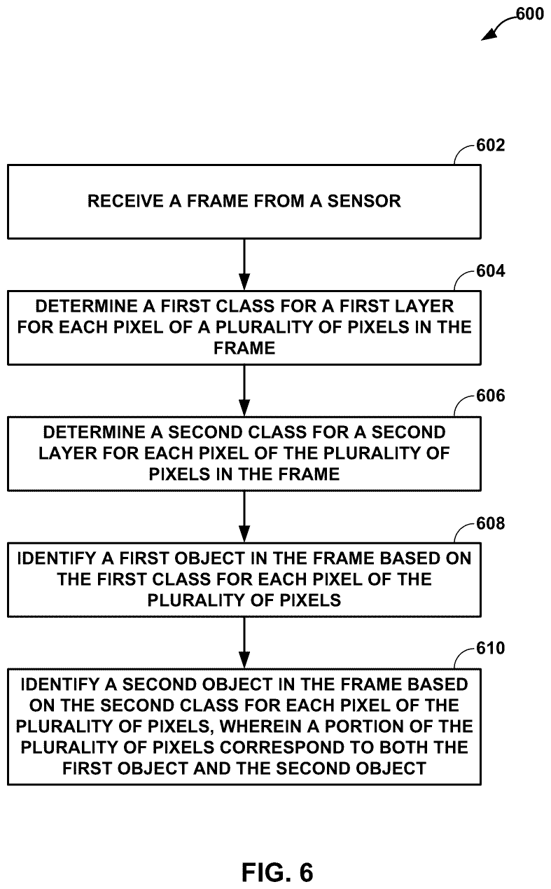

FIG. 6 is a flowchart illustrating an example process 600 for multi-layer object segmentation. The techniques of FIG. 6 will be described as being performed by controller 206 of FIG. 2, but other types of systems may also perform the described techniques. The techniques of FIG. 6 may, for example, be implemented by first encoder 504 and second encoder 524 of FIG. 5.

Controller 206 receives a frame from a sensor (602). The sensor may, for example, be one of LiDAR system 202 or camera 204 of processing system 200 or some other such sensor.

Controller 206 determines a first class for a first layer, such as a foreground layer, for each pixel of a plurality of pixels in the frame (604). Controller 206 determines a second class for a second layer, such as a background layer, for each pixel of the plurality of pixels in the frame (606). In some implementations, each pixel may have additional layers between the first layer and the second layer.

Controller 206 identifies a first object in the frame based on the first class for each pixel of the plurality of pixels (608). Controller 206 identifies a second object in the frame based on the first class for each pixel of the plurality of pixels and based on the second class for each pixel of the plurality of pixels, with a portion of the plurality of pixels corresponding to both the first object and the second object (610). The first object and the second object may, for example, be included in perspective view features 506 output by first encoder 504 or in the set of 3D sparse features 526 output by second encoder 524 of FIG. 5.

The following numbered clauses illustrate one or more aspects of the devices and techniques described in this disclosure.

Clause 1. A system comprising: one or more memories configured to store frames of data received from a sensor; and processing circuitry configured to: receive a frame of the frames; determine a first class for a first layer for each pixel of a plurality of pixels in the frame; determine a second class for a second layer for each pixel of the plurality of pixels in the frame; identify a first object in the frame based on the first class for each pixel of the plurality of pixels; and identify a second object in the frame based on the first class for each pixel of the plurality of pixels and based on the second class for each pixel of the plurality of pixels, wherein a portion of the plurality of pixels correspond to both the first object and the second object.

Clause 2. The system of clause 1, wherein to determine the first class for the first layer for each pixel of the plurality of pixels in the frame and to determine the second class for the second layer for each pixel of the plurality of pixels in the frame, the processing circuitry is configured to input the frame into a dynamic neural network.

Clause 3. The system of clause 2, wherein the dynamic neural network comprises a neural network trained using multi-layer training data, wherein the multi-layer training data includes training frames, with each training frame including a plurality of annotated pixels, each annotated pixel having a plurality of corresponding layers, and each corresponding layer being assigned to a class from a set of classes.

Clause 4. The system of any of clauses 1-3, wherein to determine the first class for the first layer for each pixel of the plurality of pixels in the frame, the processing circuitry is configured to assign a respective first class for each pixel to one class from a set of classes and to determine the second class for the second layer for each pixel of the plurality of pixels in the frame, the processing circuitry is configured to assign a respective second class for each pixel to the one class or another class from the set of classes.

Clause 5. The system of any of clauses 1-4, wherein the processing circuitry is further configured to determine a third class for a third layer for each pixel of the plurality of pixels in the frame.

Clause 6. The system of any of clauses 1-5, wherein the first layer corresponds to a foreground layer of the frame and the second layer corresponds to a background layer of the frame that is behind the foreground layer.

Clause 7. The system of any of clauses 1-6, wherein a portion of the first object occludes a portion of the second object, and wherein the processing circuitry is further configured to: determine that pixels occluded by the first object correspond to the second object based on the occluded pixels being assigned to the first class for the first layer and to the second class for the second layer.

Clause 8. The system of any of clauses 1-7, wherein the processing circuitry is further configured to determine a number of layers for each pixel of the plurality of pixels in the frame based on a scenario of the frame.

Clause 9. The system of any of clauses 1-8, wherein the sensor comprises a LiDAR sensor.

Clause 10. The system of any of clauses 1-8, wherein the sensor comprises a camera.

Clause 11. The system of any of clauses 1-10, wherein the one or more processors are part of an advanced driver assistance system (ADAS).

Clause 12. The system of any of clauses 1-10, wherein the one or more processors are external to an advanced driver assistance system (ADAS).

Clause 13. A method comprising: receiving a frame from a sensor; determining a first class for a first layer for each pixel of a plurality of pixels in the frame; determining a second class for a second layer for each pixel of the plurality of pixels in the frame; identifying a first object in the frame based on the first class for each pixel of the plurality of pixels; and identifying a second object in the frame based on the first class for each pixel of the plurality of pixels and based on the second class for each pixel of the plurality of pixels, wherein a portion of the plurality of pixels correspond to both the first object and the second object.

Clause 14. The method of clause 13, wherein determining the first class for the first layer for each pixel of the plurality of pixels in the frame and to determine the second class for the second layer for each pixel of the plurality of pixels in the frame comprises inputting the frame into a dynamic neural network.

Clause 15. The method of clause 14, wherein the dynamic neural network comprises a neural network trained using multi-layer training data, wherein the multi-layer training data includes training frames, with each training frame including a plurality of annotated pixels, each annotated pixel having a plurality of corresponding layers, and each corresponding layer being assigned to a class from a set of classes.

Clause 16. The method of any of clauses 13-15, wherein determining the first class for the first layer for each pixel of the plurality of pixels in the frame comprises assigning a respective first class for each pixel to one class from a set of classes and determining the second class for the second layer for each pixel of the plurality of pixels in the frame comprises assigning a respective second class for each pixel to the one class or another class from the set of classes.

Clause 17. The method of any of clauses 13-16, further comprising: determining a third class for a third layer for each pixel of the plurality of pixels in the frame.

Clause 18. The method of any of clauses 13-17, wherein the first layer corresponds to a foreground layer of the frame and the second layer corresponds to a background layer of the frame that is behind the foreground layer.

Clause 19. The method of any of clauses 13-18, wherein a portion of the first object occludes a portion of the second object, and wherein the method further comprises: determining that pixels occluded by the first object correspond to the second object based on the occluded pixels being assigned to the first class for the first layer and to the second class for the second layer.

Clause 20. The method of any of clauses 13-19, further comprising: determining a number of layers for each pixel of the plurality of pixels in the frame based on a scenario of the frame.

Clause 21. The method of any of clauses 13-20, wherein the sensor comprises a LiDAR sensor.

Clause 22. The method of any of clauses 13-20, wherein the sensor comprises a camera.

Clause 23. A computer-readable storage medium storing instructions that when executed by one or more processors cause the one or more processor to: receive a frame from a sensor; determine a first class for a first layer for each pixel of a plurality of pixels in the frame; determine a second class for a second layer for each pixel of the plurality of pixels in the frame; identify a first object in the frame based on the first class for each pixel of the plurality of pixels; and identify a second object in the frame based on the first class for each pixel of the plurality of pixels and based on the second class for each pixel of the plurality of pixels, wherein a portion of the plurality of pixels correspond to both the first object and the second object.

Clause 24. The computer-readable storage medium of clause 23, wherein to determine the first class for the first layer for each pixel of the plurality of pixels in the frame and to determine the second class for the second layer for each pixel of the plurality of pixels in the frame, the instructions cause the one or more processors to input the frame into a dynamic neural network.

Clause 25. The computer-readable storage medium of clause 24, wherein the dynamic neural network comprises a neural network trained using multi-layer training data, wherein the multi-layer training data includes training frames, with each training frame including a plurality of annotated pixels, each annotated pixel having a plurality of corresponding layers, and each corresponding layer being assigned to a class from a set of classes.

Clause 26. The computer-readable storage medium of any of clauses 23-25, wherein to determine the first class for the first layer for each pixel of the plurality of pixels in the frame comprises assigning a respective first class for each pixel to one class from a set of classes and to determine the second class for the second layer for each pixel of the plurality of pixels in the frame, the instructions cause the one or more processors to assign a respective second class for each pixel to the one class or another class from the set of classes.

Clause 27. The computer-readable storage medium of any of clauses 23-26, wherein when executed by one or more processors, the instructions cause the one or more processor to: determine a third class for a third layer for each pixel of the plurality of pixels in the frame.

Clause 28. The computer-readable storage medium of any of clauses 23-27, wherein the first layer corresponds to a foreground layer of the frame and the second layer corresponds to a background layer of the frame that is behind the foreground layer.

Clause 29. The computer-readable storage medium of any of clauses 23-28, wherein a portion of the first object occludes a portion of the second object, and wherein when executed by one or more processors, the instructions cause the one or more processor to: determine that pixels occluded by the first object correspond to the second object based on the occluded pixels being assigned to the first class for the first layer and to the second class for the second layer.

Clause 30. The computer-readable storage medium of any of clauses 23-29, wherein when executed by one or more processors, the instructions cause the one or more processor to: determine a number of layers for each pixel of the plurality of pixels in the frame based on a scenario of the frame.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A system comprising:
one or more memories configured to store frames of data received from a sensor; and
processing circuitry configured to:
receive a frame of the frames;
determine a first class for a first layer for each pixel of a plurality of pixels in the frame;
determine a second class for a second layer for each pixel of the plurality of pixels in the frame;
identify a first object in the frame based on the first class for each pixel of the plurality of pixels; and
identify a second object in the frame based on the first class for each pixel of the plurality of pixels and based on the second class for each pixel of the plurality of pixels, wherein a portion of the plurality of pixels correspond to both the first object and the second object.

2. The system of claim 1, wherein to determine the first class for the first layer for each pixel of the plurality of pixels in the frame and to determine the second class for the second layer for each pixel of the plurality of pixels in the frame, the processing circuitry is configured to input the frame into a dynamic neural network.

3. The system of claim 2, wherein the dynamic neural network comprises a neural network trained using multi-layer training data, wherein the multi-layer training data includes training frames, with each training frame including a plurality of annotated pixels, each annotated pixel having a plurality of corresponding layers, and each corresponding layer being assigned to a class from a set of classes.

4. The system of claim 1, wherein to determine the first class for the first layer for each pixel of the plurality of pixels in the frame, the processing circuitry is configured to assign a respective first class for each pixel to one class from a set of classes and to determine the second class for the second layer for each pixel of the plurality of pixels in the frame, the processing circuitry is configured to assign a respective second class for each pixel to the one class or another class from the set of classes.

5. The system of claim 1, wherein the processing circuitry is further configured to determine a third class for a third layer for each pixel of the plurality of pixels in the frame.

6. The system of claim 1, wherein the first layer corresponds to a foreground layer of the frame and the second layer corresponds to a background layer of the frame that is behind the foreground layer.

7. The system of claim 1, wherein a portion of the first object occludes a portion of the second object, and wherein the processing circuitry is further configured to:
determine that pixels occluded by the first object correspond to the second object based on the occluded pixels being assigned to the first class for the first layer and to the second class for the second layer.

8. The system of claim 1, wherein the processing circuitry is further configured to determine a number of layers for each pixel of the plurality of pixels in the frame based on a scenario of the frame.

9. The system of claim 1, wherein the sensor comprises one or more of a LiDAR sensor or a camera.

10. The system of claim 1, wherein the one or more processors are part of an advanced driver assistance system (ADAS).

11. The system of claim 1, wherein the one or more processors are external to an advanced driver assistance system (ADAS).

12. A method comprising:
receiving a frame from a sensor;
determining a first class for a first layer for each pixel of a plurality of pixels in the frame;
determining a second class for a second layer for each pixel of the plurality of pixels in the frame;
identifying a first object in the frame based on the first class for each pixel of the plurality of pixels; and
identifying a second object in the frame based on the first class for each pixel of the plurality of pixels and based on the second class for each pixel of the plurality of pixels, wherein a portion of the plurality of pixels correspond to both the first object and the second object.

13. The method of claim 12, wherein determining the first class for the first layer for each pixel of the plurality of pixels in the frame and to determine the second class for the second layer for each pixel of the plurality of pixels in the frame comprises inputting the frame into a dynamic neural network.

14. The method of claim 13, wherein the dynamic neural network comprises a neural network trained using multi-layer training data, wherein the multi-layer training data includes training frames, with each training frame including a plurality of annotated pixels, each annotated pixel having a plurality of corresponding layers, and each corresponding layer being assigned to a class from a set of classes.

15. The method of claim 12, wherein determining the first class for the first layer for each pixel of the plurality of pixels in the frame comprises assigning a respective first class for each pixel to one class from a set of classes and determining the second class for the second layer for each pixel of the plurality of pixels in the frame comprises assigning a respective second class for each pixel to the one class or another class from the set of classes.

16. The method of claim 12, further comprising:
determining a third class for a third layer for each pixel of the plurality of pixels in the frame.

17. The method of claim 12, wherein the first layer corresponds to a foreground layer of the frame and the second layer corresponds to a background layer of the frame that is behind the foreground layer.

18. The method of claim 12, wherein a portion of the first object occludes a portion of the second object, and wherein the method further comprises:
determining that pixels occluded by the first object correspond to the second object based on the occluded pixels being assigned to the first class for the first layer and to the second class for the second layer.

19. The method of claim 12, further comprising:
determining a number of layers for each pixel of the plurality of pixels in the frame based on a scenario of the frame.

20. The method of claim 13, wherein the sensor comprises one or more of a LiDAR sensor or a camera.

21. A computer-readable storage medium storing instructions that when executed by one or more processors cause the one or more processor to:
receive a frame from a sensor;
determine a first class for a first layer for each pixel of a plurality of pixels in the frame;
determine a second class for a second layer for each pixel of the plurality of pixels in the frame;
identify a first object in the frame based on the first class for each pixel of the plurality of pixels; and
identify a second object in the frame based on the first class for each pixel of the plurality of pixels and based on the second class for each pixel of the plurality of pixels, wherein a portion of the plurality of pixels correspond to both the first object and the second object.
